(19) United States
(12) Patent Application Publication
(10) Pub. No.: US 2026/0210298 A1
(43) Pub. Date: Jul. 23, 2026

(54) SPEED REDUCTION DEVICE COMPRISING A CASING PROVIDED WITH OIL GUIDE RELIEFS, AND AERONAUTICAL PROPULSION ASSEMBLY COMPRISING SUCH A DEVICE

(71) Applicants: SAFRAN AIRCRAFT ENGINES, PARIS (FR); SAFRAN TRANSMISSION SYSTEMS, COLOMBES (FR)

(72) Inventors: Jonathan Jean-Pierre ROUFFET, Moissy-Cramayel (FR); Patrice Jocelyn Francis Gedin, Moissy-Cramayel (FR); Antoine Jacques Marie Pennacino, Moissy-Cramayel (FR)

(73) Assignees: SAFRAN AIRCRAFT ENGINES, PARIS (FR); SAFRAN TRANSMISSION SYSTEMS, COLOMBES (FR)

(21) Appl. No.: 19/569,333

(22) Filed: Mar. 17, 2026

Related U.S. Application Data
(63) Continuation of application No. PCT/FR2024/051199, filed on Sep. 13, 2024.

(30) Foreign Application Priority Data
Sep. 18, 2023 (FR) 23/09825

(51) Int. Cl. F02C 7/36; F02C 7/06

(52) U.S. Cl. CPC F02C 7/36; F02C 7/06; F05D 2220/323; F05D 2250/18; F05D 2260/40311; F05D 2260/98

(57) ABSTRACT

A speed reduction device for an aeronautical propulsion assembly includes a ring gear, a sun gear, at least one planet gear, an oil supply circuit for at least one of the sun gear, the ring gear, the at least one planet gear, and the planet carrier, and an annular casing which houses the ring gear, the sun gear, the at least one planet gear, and the planet carrier. The annular casing has a radially inner face and an oil collector that discharges the oil via gravity. The radially inner face includes a plurality of reliefs distributed in the circumferential direction.

### CROSS-REFERENCE TO RELATED APPLICATIONS

This application is a continuation of International Application No. PCT/FR2024/051199, filed on Sep. 13, 2024, which claims priority to and the benefit of FR 2309825, filed on Sep. 18, 2023. The disclosures of the above applications are incorporated herein by reference.

### FIELD

The present disclosure relates to a speed reduction device for an aeronautical propulsion assembly and an aeronautical propulsion assembly equipped with such a speed reduction device.

### BACKGROUND

The statements in this section merely provide background information related to the present disclosure and may not constitute prior art.

In the present disclosure, the term “aeronautical propulsion assembly” refers to all turbomachines or gas turbine apparatuses that produce motive power, dedicated to the propulsion of an aircraft, and equipped with a nacelle or not. Among these apparatuses, mention may in particular be made between turbojet engines, which provide a thrust desired for propulsion by reacting to the high-speed ejection of gases, and turboshaft engines, in which motive power is provided by the rotation of a drive shaft. For example, turboshaft engines are used as helicopter engines. The turboprop engines (turboshaft engine driving a propeller) are turboshaft engines used as airplane engines.

Various speed reduction devices for an aeronautical propulsion assembly are known, for example by FR3095243 or FR3041054.

### SUMMARY

This section provides a general summary of the disclosure and is not a comprehensive disclosure of its full scope or all of its features.

One form of the present disclosure relates to a speed reduction device for an aeronautical propulsion assembly, the speed reduction device comprising a ring gear, a sun gear, and at least one planet gear rotatably mounted on a planet carrier, a diameter of the ring gear being greater than a diameter of the sun gear, an oil supply circuit for at least one element among the sun gear, the ring gear, the at least one planet gear, and the planet carrier, and an annular casing which houses the ring gear, the sun gear, the at least one planet gear, and the planet carrier, the annular casing having a radially inner face facing the ring gear and an oil collector comprising an oil discharge orifice, wherein, considered in the direction of gravity, the gravity being oriented from top to bottom, the oil collector is disposed in a lower part of the casing and configured to discharge the oil by means of gravity, the radially inner face of the annular casing comprising a plurality of reliefs which are distributed in the circumferential direction, the plurality of reliefs being configured to circulate the oil originating from the at least one element and received by the radially inner face, along the radially inner face to the oil collector.

Generally, the axial direction corresponds to the direction of the rotational axis of the planet carrier or of the ring gear, which, when the speed reduction device is mounted on a propulsion assembly, corresponds to the rotational axis of the gas generator. A radial direction is a direction perpendicular to the axial direction. The azimuthal or circumferential direction corresponds to the direction describing a ring around the axial direction. The three axial, radial, and azimuthal (or circumferential) directions correspond respectively to the directions defined by the side, the radius, and the angle in a cylindrical coordinate system. Furthermore, upstream and downstream are defined relative to the normal flow direction of the fluid (from upstream to downstream) through the aeronautical propulsion assembly. Finally, unless otherwise indicated, the adjectives internal/inner and external/outer are used in reference to the radial direction so that the inner (i.e., radially inner) part of an element is closer to the axis defining the axial direction than the outer (i.e., radially outer) part of the same element.

A speed reduction device for an aeronautical propulsion assembly is, for example, a device configured to rotationally couple a driving shaft of a gas generator, for example a low-pressure spool shaft when the propulsion assembly comprises a low-pressure spool and a high-pressure spool, with a, shrouded or unshrouded, fan shaft and configured to drive the fan shaft at a rotational speed lower than the rotational speed of the driving shaft. Hereinafter, and unless otherwise indicated, “reduction device” means “speed reduction device”.

For example, the speed reduction device may be an epicyclic gear train reduction device, for example of the “epicyclic” or “planetary” type, according to the terminology sometimes used by those skilled in the art. Such a device may comprise one stage, two stages, or more than two stages.

According to a first variant, the reduction device may be of the planetary or “star” type and comprises a sun gear, which forms the input of the reduction device. The rotational axis of the sun gear forms the rotational axis of the reduction device and may coincide with the axis of the propulsion assembly. The sun gear is configured to be driven by a driving shaft. The ring gear forms the output of the reduction device. The ring gear is coaxial with the sun gear and configured to drive in rotation a fan shaft about the axis. Several planets, or planet gears, may be distributed circumferentially about the axis between the sun gear and the ring gear. Each planet is meshed with the sun gear and with the ring gear. The planets are mounted on a planet carrier that is configured to be fixed relative to a stator part of a propulsion assembly, for example, relative to an upstream compressor casing.

According to a second variant, the reduction device may be of the epicyclic or “planetary” type. In this case, compared to the planetary type according to the first variant, the ring gear is configured to be fixedly mounted on a stator part of the propulsion assembly, and the propeller shaft is driven in rotation by the planet carrier (which is therefore rotatably movable relative to the stator part of the propulsion assembly, for example, relative to a casing upstream of the compressor). The stator parts of the first and second variants may correspond to different parts of the same element, or correspond to distinct elements.

Regardless of the configuration of the reduction device, the diameter of the ring gear is larger than the diameter of the planet carrier, which is itself larger than the diameter of the sun gear. The planets are radially disposed between the sun gear and the ring gear, and the output rotational speed is lower than the input rotational speed.

The reduction ratio of the reduction device may be greater than or equal to 2.5 and less than or equal to 14.0.

The casing may comprise a single collector or several collectors. The collector, or each collector, may comprise a single orifice or several orifices. Considered in the direction of gravity, particularly when the speed reduction device is mounted on an aeronautical propulsion assembly in normal operating position (i.e., when the aircraft on which the propulsion assembly is mounted is in normal operating conditions, i.e., on the ground, in cruise flight, during takeoff phase, or during landing phase), the collector is disposed in the lower part of the casing. For example, the casing has a median plane perpendicular to the direction of gravity and comprising the rotational axis of the planet carrier or of the ring gear, and considered in the orientation of gravity, the part of the casing disposed above this median plane forms an upper part of the casing, and the part of the casing disposed below this median plane forms the lower part of the casing. According to one variant, the upper/lower parts may extend over 25% of the extent of the casing in the direction of gravity, from the highest/lowest point, respectively, of the casing considered in the direction of gravity. The collector is configured so that the oil discharges by means of gravity, that is to say, it flows naturally through the orifice due to gravitational effect.

The reliefs may be raised or recessed reliefs and, considered individually, are distinct from deflectors (i.e., each relief does not form a deflector on its own, nor is it sufficient to guide an oil flow by itself). The reliefs are configured to act synergistically and, together, guide the circulation of oil received on the radially inner face by projection due to the rotation of the different lubricated rotating elements of the reduction device, along the entire length of the radially inner face, and this from the point of impact of the different oil projections to the collector. For example, each of the reliefs may facilitate the adhesion of the oil projections to the radially inner face upon impact of the projections on the radially inner face, and thus inhibiting potential rebound of the projections elsewhere within the reduction device. Such rebounds of oil projections may lead to a recirculation of all or part of the oil projections towards the rotating parts of the reducer, which may induce undue energy losses and undesirable oil heating. Through a synergistic effect, the set of reliefs may then promote the flow of the oil thus recovered on the radially inner face towards the collector, for example towards the discharge orifice, and “calm down” an oil flow that might otherwise tend to become turbulent.

The annular casing may have a radially outer face, opposite the radially inner face. This radially outer face may be subjected, during operation when the reduction device is mounted on an aeronautical propulsion assembly, to a temperature different from the temperature inside the casing and/or the oil temperature. The reliefs may promote heat exchange between the recovered oil projections and the radially outer face of the casing, for example, to cool the oil, such as if the annular casing internally delimits a primary gas flow path at the inlet of a gas generator, upstream of a compressor.

In some forms, each relief of the plurality of reliefs may consist of a projection extending radially inwards from the radially inner face.

For example, the reliefs may be normal to (or extend perpendicularly from) the radially inner face. Such protruding reliefs may be particularly effective, for example, for both redirecting and cooling oil.

According to a variant, the plurality of reliefs may also comprise a portion extending radially outwards from the radially outer face. In other words, the reliefs may comprise a radially inner portion and a radially outer portion, for example, radially aligned with each other. In other words, the reliefs may extend radially on either side of the wall of the casing. This may make it possible to increase the heat exchange surface area between the wall and the air outside the enclosure. With an outside air temperature lower than that of the oil inside the enclosure, it is clear that oil cooling is improved due to better heat dissipation thanks to the cooling of the reliefs by the outside air and the continuity of material of the reliefs between the radially inner portion and the radially outer portion.

In some forms, each projection may have a radial thickness less than or equal to 40.00 mm (forty millimeters), for example less than or equal to 25.00 mm (twenty-five millimeters), and greater than 0.10 mm (ten hundredths of a millimeter).

Such radial thicknesses may make it possible to obtain a good balance between the effectiveness of the reliefs and the added weight they may represent.

In some forms, the reliefs of the plurality of reliefs may all be disposed in positions distinct from the position of the oil collector.

For example, the reliefs may all be disposed axially and circumferentially at positions distinct from the axial and azimuthal position of the oil collector, and in particular of the oil discharge orifice. In other words, considered in the radial direction, the reliefs do not extend in front of the oil collector, and specifically not in front of the oil discharge orifice of the oil collector. Such a configuration may make it possible to improve the efficiency of the oil collector by increasing access to the collector from the enclosure delimited by the casing, while the reliefs provide adhesion and guidance for the oil projections received by the radially inner face of the casing.

In some forms, the plurality of reliefs may form at least one regular pattern, for example a chevron pattern, a broken line pattern, a spike pattern, a star pattern, a curved line pattern, a straight line pattern, a rice grain pattern, or any combination of these forms.

Such patterns may make it possible to improve the synergy of the reliefs and the efficiency of the adhesion and guidance of the recovered oil. This may also improve cooling efficiency in the case of an annular casing where the outer radial face is cooler than the inner radial face.

In some forms, the reliefs of the plurality of reliefs may each have a radial end, the reliefs each having a progressive shape thinning from the radially inner face to the radial end.

For example, the progressive shape may be thinned considered in a cross section of the relief. Such a configuration may make it possible to improve the weight represented by the multiple reliefs, improve the adhesion and guidance of the oil projections received by the radially inner face of the casing, and/or allow for better heat exchange with the oil.

In some forms, the speed reduction device may comprise an axis and an axial plane extending parallel to the axis and containing the axis, the axial plane passing through the oil collector, the reliefs of the plurality of reliefs being disposed symmetrically with respect to the axial plane.

In other words, the axial plane extends radially parallel to the axis (or to the axial direction) and contains the axis. The axial plane may, for example, pass through the geometric center of the orifice of the oil collector. For example, such a configuration may improve the guidance of the oil by means of gravity towards the collector, for example, the reliefs being oriented towards the collector (or towards the lowest point of the reducer), that is to say in the direction of the shortest circumferential path to connect to the collector. Such a configuration may make it possible to provide a degree of versatility in the reliefs, which may have the same efficiency regardless of the rotational direction of the rotating elements of the reducer.

In some forms, the speed reduction device may comprise an axis and a radial plane extending perpendicularly to the axis, the reliefs of the plurality of reliefs being disposed symmetrically with respect to the radial plane.

In other words, the radial plane extends parallel to the radial direction and perpendicular to the axis (or to the axial direction). The radial plane may, for example, pass through the geometric center of the orifice of the oil collector. For example, such a configuration may make it possible to improve the guidance of the oil by means of gravity towards the collector, for example, the reliefs being oriented circumferentially and/or axially towards the collector. For example, the casing may have a concave shape with the concavity oriented radially inwards, so that such a configuration of the reliefs may make it possible to improve the guidance of the oil towards the bottom of the concave shape, i.e., towards the point radially furthest from the axis of the radially inner face, which may further improve the guidance by means of gravity towards the collector, for example, towards the orifice (which may, for example, also be disposed at the bottom of the concave shape).

In some forms, the speed reduction device may comprise an intermediate gutter disposed radially between the casing and the ring gear, the gutter being perforated.

In other words, the gutter comprises through perforations. The shape of the perforations of the gutter may be configured to promote the guidance of the oil projections towards predetermined impact areas of the radially inner face of the casing, for example, areas where the reliefs extend. Generally, the gutter may be perforated so as to improve the oil circulation within the reduction device.

In some forms, the ring gear is rotating and has a plurality of radially extending through ducts configured to conduct oil from the inside of the ring gear to the outside of the ring gear, each of the ducts having at least one portion inclined with respect to the radial direction.

For example, the ducts may each be parallel to a plane perpendicular to the axial direction and be inclined, in whole or in part, to the radial direction within said perpendicular plane. According to another example, the ducts may each be parallel to a so-called radial plane extending radially and comprising the axis of revolution of the ring gear or of the planet carrier, and be inclined, in whole or in part, to the radial direction within the radial plane (i.e., forming an angle strictly less than 90¬∞ with the axial direction). According to yet another example, the ducts may each be inclined in the radial direction according to a combination of the two preceding examples. For example, the casing may comprise two parts forming two half-casings and assembled together via two respective radial flanges and each having a joint plane extending perpendicular to the axial direction, the ducts being formed by the two flanges, for example, in the two joint planes.

One form relates to an aeronautical propulsion assembly comprising a speed reduction device according to any one of the forms described in the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates an aircraft equipped with an aircraft propulsion assembly according to one form of the present disclosure;

FIG. 2 is a schematic of a cross-sectional view of the aircraft propulsion assembly of FIG. 1;

FIG. 3 is a schematic of a radial cross-sectional view of the speed reducer of the aircraft propulsion assembly of FIG. 2;

FIG. 4 is a schematic of an axial cross-sectional view of the speed reducer of the aircraft propulsion assembly of FIG. 2;

FIG. 5 illustrates several variants of the shape of reliefs and patterns according to the present disclosure;

FIG. 6 illustrates a variant of the casing comprising a single pattern of reliefs according to the present disclosure;

FIG. 7 illustrates a variant of the casing comprising two distinct patterns according to the present disclosure; and

FIG. 8 illustrates a shape of the perforations of the gutter according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

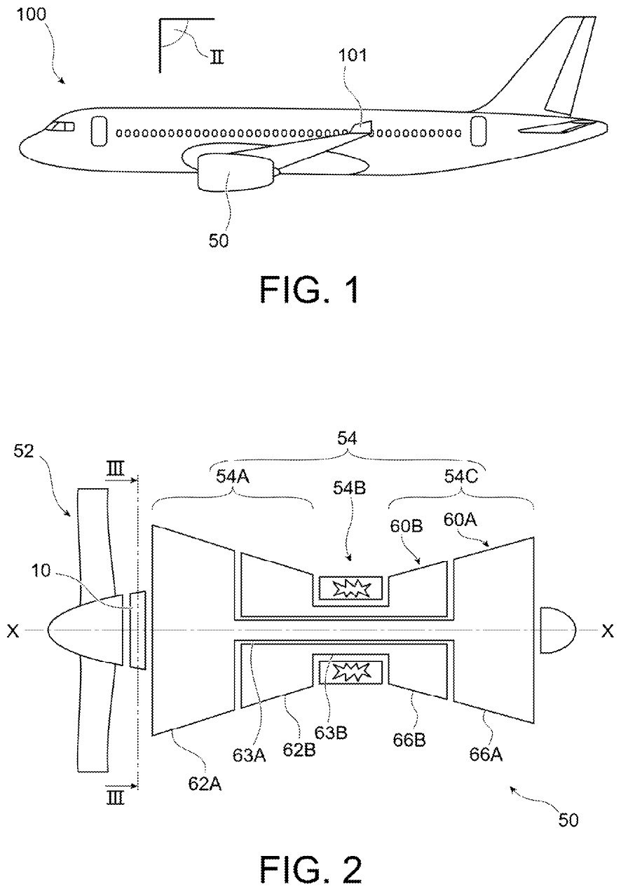

FIG. 1 illustrates an aircraft 100, in this example an airplane, equipped with two turbomachines 50, in this example two aeronautical propulsion assemblies 50, in this example two turbojet engines 50, namely one turbomachine 50 per wing 101, only one turbomachine 50 and one wing 101 being represented in FIG. 1. According to one variant, the aircraft 100 may be equipped with more than one turbomachine 50 per wing 101, each wing 101 being provided with the same number of turbomachines 50.

FIG. 2 represents a schematic cross-sectional view of the turbomachine 50, according to the plan II of FIG. 1. The turbomachine 50 comprises a fan 52, which may be shrouded or unshrouded, and a gas generator 54 (in the example of FIG. 1, the fan 52 being shrouded). In this example, the gas generator 54 comprises, from upstream to downstream, gases flowing within the turbomachine 50 from upstream to downstream, a compressor 54A (or compressor section 54A), a combustion chamber 54B, and a turbine 54C (or turbine section 54C). In this example, the fan 52 may be driven in rotation by a shaft of the gas generator 54, for example, a shaft of a low-pressure spool, through a speed reducer 10.

The gas generator 54 may be of the twin-spool type and comprise a low-pressure spool 60A and a high-pressure spool 60B. The low-pressure spool 60A may comprise a low-pressure compressor 62A rotationally coupled to a low-pressure turbine 66A through a low-pressure shaft 63A. The high-pressure spool 60B may comprise a high-pressure compressor 62B disposed downstream of the low-pressure compressor 62A and upstream of the combustion chamber 54B, and a high-pressure turbine 66B disposed downstream of the combustion chamber 54B and upstream of the low-pressure turbine 66A, and rotationally coupled to the high-pressure compressor 62B through a high-pressure shaft 63B. The compressor 54A of the gas generator 54 may comprise the low-pressure and high-pressure compressors 62A and 62B. The turbine 54C of the gas generator 30 may comprise the low-pressure and high-pressure turbines 66A and 66B. FIG. 2 is schematic, each compressor and each turbine being able to have one or more stages, each stage comprising a moving wheel and a stator or guide vane.

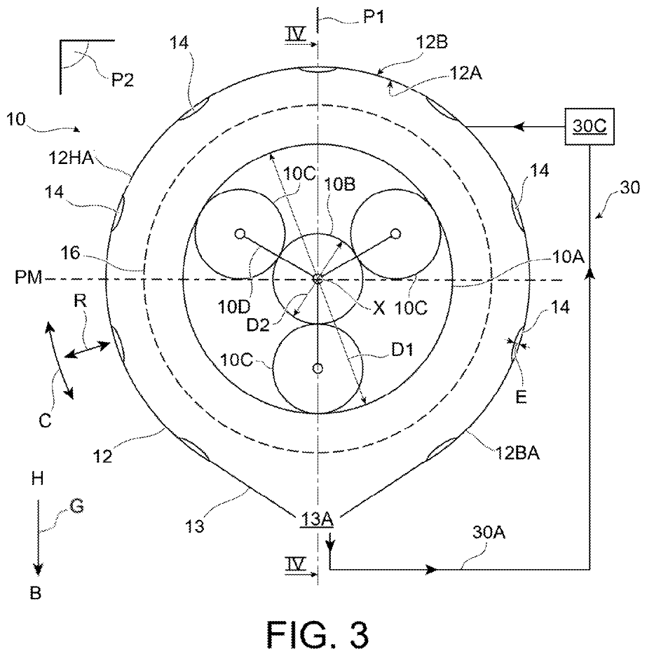

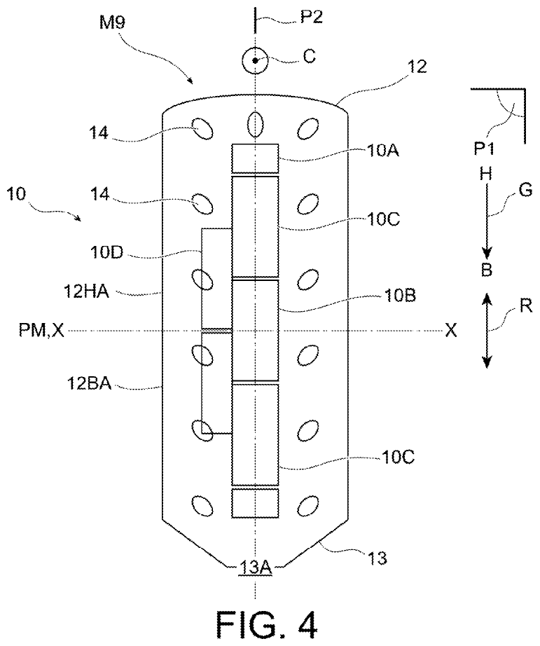

FIG. 3 represents a cross-sectional view of the speed reducer 10 along the plane III of FIG. 2. FIG. 4 represents the reducer 10 along a cross section IV of FIG. 3. Hereafter, unless otherwise indicated, the reducer 10 is described with reference to FIGS. 3 and 4. The reducer 10 comprises a ring gear 10A, a sun gear 10B, and at least one planet gear 10C rotatably mounted on a planet carrier 10D. The reducer 10 may be of the planetary or epicyclic type. In this example, the reducer 10 comprises three planet gears 10C, but the reducer 10 may comprise fewer than three planet gears or more than three planet gears. The diameter D1 of the ring gear 10A is larger than the diameter D2 of the sun gear 10B. For the clarity of FIG. 3, the teeth of the ring gear 10A, the sun gear 10B, and the at least one planet gear 10C are not represented. The at least one planet gear 10C meshes with the sun gear 10B and the ring gear 10A. The sun gear 10B rotates around the axis X of the reduction device 10, which in this example coincides with the axis of the propulsion assembly 50 when the reducer 10 is mounted within the propulsion assembly 50.

The reducer 10 comprises an oil supply circuit 30, configured to supply oil to at least one element among the sun gear 10B, the ring gear 10A, the at least one planet gear 10C and the planet carrier 10D, for example for the lubrication and/or cooling of all or part of the bearings and/or teeth of this at least one element.

The reducer 10 comprises an annular casing 12 which houses the ring gear 10A, the sun gear 10B, the at least one planet gear 10C, and the planet carrier 10D. The annular casing 12 has a radially inner face 12A facing the ring gear 10A. The casing 12 may have a radially outer face 12B, which may, for example, delimit a radially inner portion of a primary gas flow path, i.e., the flow path of gas circulating in the gas generator 54, and be in direct contact with the gases circulating from the fan 52 to the low-pressure compressor 54A.

The casing 12 has an oil collector 13, in this example a single collector 13, comprising an oil discharge orifice 13A, in this example a single orifice 13A. Considered in the direction of gravity G, the gravity G being oriented from the top H to the bottom B, the oil collector 13 is disposed in a lower part 12BA of the casing 12. For example, the casing 12 has a median plane PM perpendicular to the direction of gravity G and comprising the rotational axis X of the planet carrier or of the ring gear, and considered along the orientation of gravity G, the part of the casing disposed above this median plane PM forms an upper part 12HA of the casing 12 and the part of the casing disposed below this median plane PM forms the lower part 12BA of the casing 12. The oil collector 13 is configured to discharge the oil by means of gravity. For example, as may be seen in FIG. 4, the casing 12 may have a concave shape with the concavity oriented radially inwards (i.e., towards the axis X). For example, the orifice 13A is provided at the lowest point of the casing 12, considered in the direction of Earth's gravity G, the Earth's gravity G being oriented downwards, at the bottom of the concave or semi-toroidal shape of the casing 12. The oil supply circuit 13 may be configured to recover oil from the collector 13, for example via a recovery pipe 30A, and to reinject oil into the reducer 10 towards the at least one element among the sun gear 10B, the ring gear 10A, the at least one planet gear 10C, and the planet carrier 10D, for example via an injection pipe 30B. For example, the circuit 30 may comprise an oil circulation pump 30C. The circuit 30 may also distribute oil to other components of the propulsion assembly 50, but not necessarily. The circuit 30 may comprise a heat exchanger (not represented) to cool and/or heat the oil, but not necessarily.

The radially inner face 12A of the annular casing 12 is provided with a plurality of reliefs 14 distributed in the circumferential direction C. The plurality of reliefs 14 is configured to circulate the oil originating from the at least one element among the sun gear 10B, the ring gear 10A, the at least one planet gear 10C and the planet carrier 10D, and received by the radially inner face 12A, along the radially inner face 12A in the circumferential direction C, to the oil collector 13.

For example, as represented in FIG. 3, each relief 14 of the plurality of reliefs may consist of a projection extending radially (i.e., in the radial direction R) inwards from the radially inner face 12A.

For example, each projection has a radial thickness E less than or equal to 40.00 mm, for example less than or equal to 25.00 mm, and greater than 0.10 mm. For the purposes of the present disclosure, the radial thickness E is understood to be the maximum thickness of the relief 14, in a cross section normal to the radially inner face 12A.

For example, the reliefs 14 of the plurality of reliefs may all be disposed in positions distinct from the position of the oil collector 13, in particular of the orifice 13A.

For example, each relief 14 of the plurality of reliefs may have the shape of a continuous or broken straight line, a curved line, a spike, a star, a rice grain, etc. In the example represented in FIGS. 3 and 4, the reliefs have the shape of a rice grain. For example, the plurality of reliefs may form at least one regular pattern. In the example represented in FIGS. 3 and 4, the plurality of reliefs forms a pattern of rice grains M9.

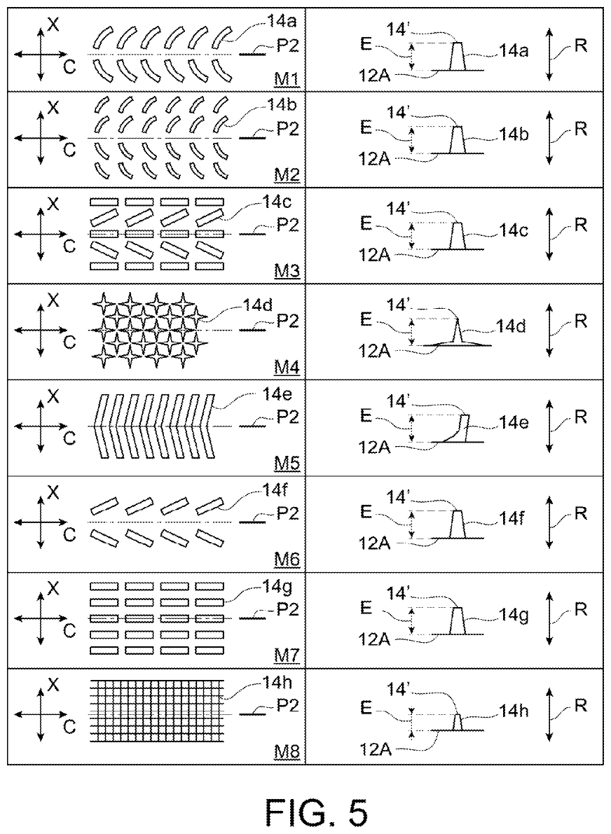

FIG. 5 illustrates several variants of shapes of reliefs and patterns. In the left column (or first column), the reliefs are shown in development in the circumferential direction C, from inside the casing 12, with the axial direction X and circumferential direction C indicated. In the right column (or second column), the cross-sectional shape of the relief of the left column is represented on the corresponding line, with the radial direction R indicated. In the represented examples, the reliefs 14 each have a progressive shape thinning from the radially inner face 12A to the radial end 14′ (see right column). The cross-sectional shape of the reliefs may have straight or curved sides, and/or have a regular or irregular geometric shape.

In the examples of the first and second lines of FIG. 5, the reliefs 14a and 14b have a curved line shape (see left column), in this example an arc shape, and form patterns of curved lines. In the first line, the pattern M1 comprises two rows symmetrical to each other in the axial direction X, the rows extending in the circumferential direction C. In the second line, the pattern M2 comprises two rows symmetrical to each other in the axial direction X, the rows extending in the circumferential direction C.

In the examples of the third, sixth, and seventh lines of FIG. 5, the reliefs 14c, 14f, and 14g have a straight line shape (see left column), in this example a segment shape. In these examples, the reliefs form patterns of discontinuous straight lines. In the third line, the pattern M3 comprises five rows of reliefs 14c, symmetrical to each other in the axial direction X with respect to the central row, the rows extending in the circumferential direction C. In this example, the pattern alternates in the axial direction X between rows of reliefs 14c extending parallel to the circumferential direction C and rows of reliefs 14c extending at a non-zero angle to the circumferential direction C, the latter all having the same orientation. In the sixth line, the pattern M6 comprises two rows of reliefs 14f, symmetrical to each other in the axial direction X, the rows extending in the circumferential direction C. In this example of pattern, the reliefs 14f extend at a non-zero angle to the circumferential direction C, all the reliefs 14f having the same orientation. In the seventh line, the pattern M7 comprises five rows of reliefs 14g, symmetrical to each other in the axial direction X, the rows extending in the circumferential direction C. In this example of pattern, the reliefs 14g extend parallel to the circumferential direction C.

In the example of the fourth line of FIG. 5, the reliefs 14d have a star shape (see left column) and together form a star pattern M4. Such a star pattern may have a “calming down” effect on the oil flow and separate/break up oil “packets” exceeding a predetermined volume or size. In this example, the stars are stars with four arms arranged orthogonally in pairs, one pair of opposite arms extending parallel to the circumferential direction C, and another pair of opposite arms extending parallel to the axial direction X. In this example, the stars are disposed in a staggered manner within the star pattern.

In the example of the fifth line of FIG. 5, the reliefs 14e have a chevron or broken line shape (see left column), and together form a pattern M5 of chevrons or broken lines (a broken line shape not necessarily having a chevron shape). In this example, the pattern comprises a single row of chevrons, extending in the circumferential direction C, all the chevrons having the same orientation.

In the example of the eighth line of FIG. 5, the reliefs 14h have a straight line shape (see left column), in this example a continuous line, and together form a pattern M8 of straight lines, in this example a grid. In this example, the grid is a regular grid, comprising a series of reliefs 14h extending parallel to the circumferential direction C and a series of reliefs 14h extending parallel to the axial direction X. Such a grid may “calm down” the oil flow and inhibit projections.

In the examples of the reliefs 14a, 14b, 14c, 14f, 14g and 14h of the first, second, third, sixth, seventh and eighth lines of FIG. 5, the shape of the cross section (see right column), normal to the radially inner face 12A, of the reliefs have a trapezoidal shape, for example an isosceles trapezoid shape, the longer side of the two parallel sides of the trapezoid being disposed on the side of the radially inner face 12A. The dimensions of these sections may vary from one shape to another.

In the example of the star-shaped relief 14d of the fourth line of FIG. 5, the cross section (see right column) has a pyramidal shape with a first portion forming a wide base and a second portion surmounting the first portion in the radial direction R, forming a tapered apex (which is narrow relative to the wide base). In this example, the base has a truncated-apex triangular shape, and the tapered apex has a triangular shape whose height is greater than the side forming the junction with the base.

In the example of chevron-shaped relief 14e of the fifth line of FIG. 5, the cross section (see right column) has a polygonal shape, the base being wider than the apex. Such a shape may be adjusted during the design according to the angle of incidence intended for the oil projections. It is understood that the rotational direction of the rotating elements of the reducer may influence this angle of incidence. Thus, a relief shape may be suitable for a given rotational direction but unsuitable for the reverse rotational direction.

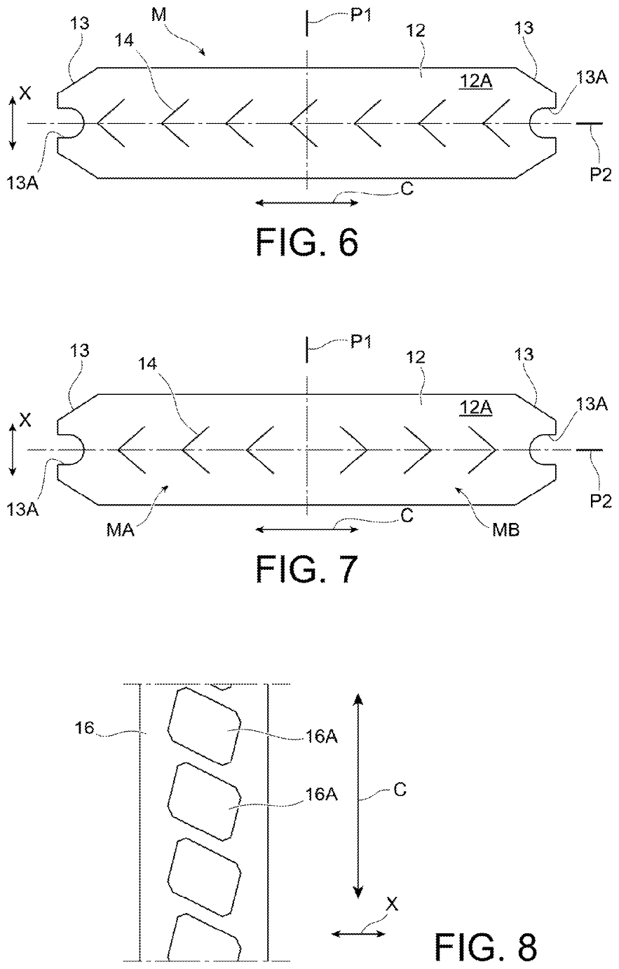

FIG. 6 illustrates a developing view of an example of the radially inner face 12A. In this variant, the reliefs 14 all have a chevron shape and form a single pattern M. For example, all the chevrons have the same orientation. Any other pattern shape is possible instead of the chevron pattern, including the patterns represented in FIG. 5 or the rice grain patterns of FIG. 4.

FIG. 7 illustrates a developing view of another example of the radially inner face 12A. In this variant, the reliefs 14 are all chevron-shaped and form two distinct patterns, namely a pattern MA and a pattern MB. In this example, within each pattern, the shape of each relief is oriented towards the collector 12, for example, towards the orifice 13A, along the shortest circumferential path. For example, in the pattern MA, all the chevrons have the same first orientation, while in the pattern MB, all the chevrons have the same second orientation, opposite to the first orientation. In this example, the plane P1 is an axial plane extending parallel to the axis X and containing the axis X, the axial plane P1 passing through the oil collector 13, in this example through the geometric center of the orifice 13A. The reliefs 14 of the plurality of reliefs are, in this example, disposed symmetrically with respect to the axial plane P1. Any other pattern shape is possible instead of the chevron pattern, including the patterns represented in FIG. 5 or the rice grain patterns of FIG. 4.

In the examples of FIGS. 4, 6, and 7, a radial plane P2 extends perpendicularly to the axis X. In this example, the radial plane P2 may pass through the geometric center of the orifice 13A. The reliefs 14 of the plurality of reliefs may be disposed symmetrically with respect to the radial plane P2. Any other pattern shape is possible instead of the patterns represented in FIGS. 4, 6, and 7, including the patterns represented in FIG. 5 (where the plane P2 is represented for illustrative purposes only and in a non-limiting manner).

With reference to FIG. 3, the reducer 10 may comprise an intermediate gutter 16 disposed radially between the casing 12 and the ring gear 10A, the gutter 16 being perforated. For example, the gutter 16 may include a plurality of perforations 16A regularly distributed in the circumferential direction C. An example of the shape of the perforations is shown in FIG. 8, which represents a partial developed view of the gutter 16. The perforations 16A may have a parallelogram shape with rounded or chamfered corners.

Although the present disclosure has been described with reference to specific forms, it is evident that modifications and changes can be made to these examples without departing from the general scope of the present disclosure as defined by the claims. In particular, individual features of the various illustrated/mentioned forms can be combined in additional aspects. Therefore, the description and the drawings should be considered in an illustrative rather than restrictive sense.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A speed reduction device for an aeronautical propulsion assembly, the speed reduction device comprising:
a ring gear;
a sun gear;
at least one planet gear rotatably mounted on a planet carrier, a diameter of the ring gear being greater than a diameter of the sun gear;
an oil supply circuit for at least one element among the sun gear, the ring gear, the at least one planet gear and the planet carrier; and
an annular casing which houses the ring gear, the sun gear, the at least one planet gear and the planet carrier, the annular casing having a radially inner face facing the ring gear and an oil collector comprising an oil discharge orifice, in which, considered in a direction of gravity, the gravity being oriented from top to bottom, the oil collector is disposed in a lower part of the annular casing and configured to discharge oil by means of gravity, the radially inner face of the annular casing comprising a plurality of reliefs distributed in a circumferential direction, the plurality of reliefs being configured to circulate the oil originating from the at least one element and received by the radially inner face, along the radially inner face to the oil collector.

2. The speed reduction device according to claim 1, wherein each relief of the plurality of reliefs consists of a projection extending radially inwards from the radially inner face.

3. The speed reduction device according to claim 2, wherein each projection has a radial thickness less than or equal to 40.00 mm.

4. The speed reduction device according to claim 1, wherein the reliefs of the plurality of reliefs are all disposed at positions distinct from a position of the oil collector.

5. The speed reduction device according to claim 1, wherein the plurality of reliefs forms at least one regular pattern, for example a chevron pattern, a broken line pattern, a spike pattern, a star pattern, a curved line pattern, a straight line pattern, a rice grain pattern, or any combination of these forms.

6. The speed reduction device according to claim 1, wherein the reliefs of the plurality of reliefs each have a radial end, the reliefs each having a progressive shape thinning from the radially inner face to the radial end.

7. The speed reduction device according to claim 1, comprising an axis and an axial plane extending parallel to the axis and containing the axis, the axial plane passing through the oil collector, the reliefs of the plurality of reliefs being disposed symmetrically with respect to the axial plane.

8. The speed reduction device according to claim 1, comprising an axis and a radial plane extending perpendicularly to the axis, the reliefs of the plurality of reliefs being disposed symmetrically with respect to the radial plane.

9. The speed reduction device according to claim 1, comprising an intermediate gutter disposed radially between the annular casing and the ring gear, the intermediate gutter being perforated.

10. An aeronautical propulsion assembly comprising the speed reduction device according to claim 1.
